(19) United States
(12) Patent Application Publication
(10) Pub. No.: US 2004/0207774 A1
(43) Pub. Date: Oct. 21, 2004

(54) Illumination apparatus for LCD/organic displays

(76) Inventor: David L. Gothard, Naples, FL (US)

Correspondence Address: EDWARD M. LIVINGSTON, PA, 963 TRAIL TERRACE DRIVE, NAPLES, FL, 34103, US

(21) Appl. No.: 10/826,586

(22) Filed: Apr. 16, 2004

Related U.S. Application Data
(60) Provisional application No. 60/464,213, filed on Apr. 17, 2003.

(51) Int. Cl. G02F 1/1335

(52) U.S. Cl. 349/64

(57) ABSTRACT

An illumination apparatus for an LCD/organic display (4) having a grid of high intensity LED lamps (1) covered by a Frenzel lens (2) and a polycarbonate glass diffuser (3). The illumination apparatus is placed behind an LCD/organic display (4) for the purpose of emitting a high intensity but uniform light, thereby eliminating any “hot spots” on the display screen (4). A covering, preferably made of clear polycarbonate glass 5, is then placed over the LCD/organic display (4) to protect the display from dust, dirt, scratches and other everyday happenings. This illumination apparatus enables LCD/organic displays (4) to be built with much larger screens than currently possible.

### CROSS REFERENCE TO RELATED APPLICATION

This application claims the benefit of U.S. Provisional Application No. 60/464,213, filed Apr. 17, 2003.

### BACKGROUND OF THE INVENTION

This invention relates to lighting apparatuses, more particularly, an apparatus for illuminating liquid crystal display (LCD) television screens and other LCD/organic displays.

LCD/organic displays have been in existence for many years but has only recently gained widespread appeal for the average consumer. Although the displays produce a crisper and clearer picture than traditional displays, there is one significant drawback: picture distortion on larger displays.

Currently, illuminating the display screen is achieved through the use of “edge lighting,” a technique wherein a panel of plastic is placed directly behind the display screen. Unfortunately, this technique severely limits the size of the display screen whereby the larger the display screen, the more the picture is distorted. Thus, if consumers desire quality of in a LCD/organic display, he or she must sacrifice the desire of having a large sized display.

Additionally, not only are LCD televisions limited in size, but the intensity of the brightness of the picture is limited as well. Accordingly, LCD televisions and displays have been limited generally to less than thirty inches in size and anything beyond thirty inches in size has been the domain of plasma and other televisions.

Another drawback commonly found in current LCD televisions and displays relates to uniform brightness quality. Due to the “edge lighting” technique, various hot spots are created within LCD televisions and displays, creating areas on the display which are brighter than others. Thus, LCD televisions and displays often appear brighter in some areas while dimmer in others.

Thus, the need exists for a new illumination apparatus to backlight an LCD/organic display screen which overcomes the problems associated with current lighting methods.

### SUMMARY OF THE INVENTION

The primary object of the present invention is to provide an illumination apparatus that yields an intense but uniform light source to illuminate an LCD/organic display screen.

Another object of the present invention is to provide an illumination apparatus that does not limit the size of an LCD/organic display screen caused by uneven or diminished light.

A further object of the present invention is to provide an illumination apparatus that is energy efficient and does not cause heat buildup.

The present invention fulfills the above and other objects by providing an illumination apparatus using a grid of high intensity lamps covered by a Frenzel lens, the light from which is diffused through a polycarbonate or glass diffusing layer. More specifically, the illumination apparatus consists of a back grid of high intensity LED lamps or other illuminating source, a Frenzel lends panel and a diffuser panel, all of which is placed behind an LCD/organic display. The result of such apparatus is a high intensity but uniform picture on the display screen.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawing in which:

FIG. 1 is a composite drawing showing a side view and front view of the illumination apparatus of the present invention used to illuminate an LCD/organic display.

### DESCRIPTION OF THE PREFERRED EMBODIMENTS

For purposes of describing the preferred embodiment, the terminology used in reference to the numbered components in the drawings is as follows:

| | |
|---|---|
| 1. LED lamps | 4. LCD/organic display |
| 2. Frenzel lenses | 5. cover |
| 3. diffuser panel | 6. background |

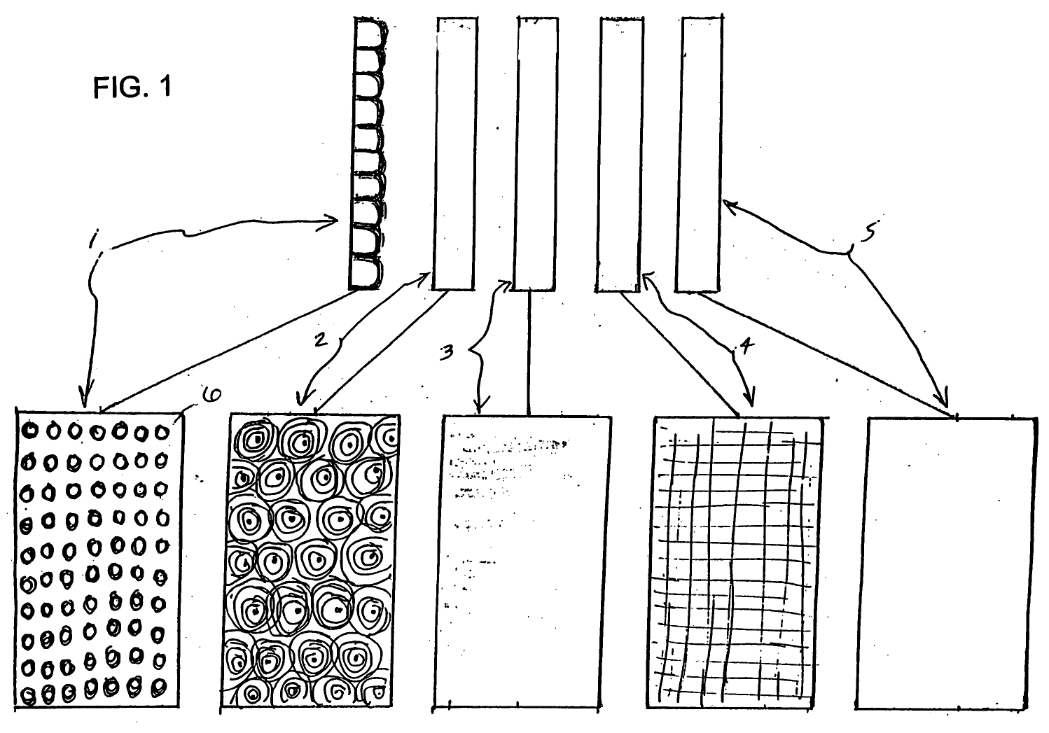

Referring to FIG. 1, the illumination apparatus of the present invention is shown. The apparatus consists primarily of three panels or layers, the first being a grid of high intensity light emitting diode (LED) lamps 1, the second being a panel or layer of Frenzel lenses 2 and the third being a diffuser panel or layer 3.

The high intensity LED lamps 1, which are preferably set against a white background 6, provide an intense light which is directed through the Frenzel lens panel 2. The Frenzel lens panel 2 further directs and intensifies the light which is then passed through the diffuser panel 3, preferably made of polycarbonate or glass. The diffuser panel 3 softens the light and provides a uniform appearance. The light from the diffuser panel 3 then illuminates the LCD/organic display 4. Finally, a cover 5, preferably made of clear polycarbonate glass, is placed over the LCD/organic display 4 to provide protection for the display 4.

The high intensity LED lamps 1 and the LED/organic display 4 are preferably ½″ in thickness while the Frenzel lenses 2, diffuser 3 and cover 5 are preferably 1/16″ in thickness, thus making the apparatus, when assembled, less than 1½″ inches thick. Although LED lamps 1 may be the current source of light in the preferred embodiment, other point sources of light could be used so long as the light emitted therefrom is of high intensity.

Although only a few embodiments of the present invention have been described in detail hereinabove, all improvements and modifications to this invention within the scope or equivalents of the claims are included as part of this invention.

Having thus described my invention, I claim:

1. An illumination apparatus for LCD/organic displays comprising:
a first panel containing a plurality of high intensity light sources;
a Frenzel lens panel placed in front of first panel;
a diffuser panel placed in front of said Frenzel lens panel; and
an LED/organic display panel placed in front of said diffuser panel.

2. The illumination apparatus for LCD/organic displays of claim 1 wherein:
the high intensity light sources on the first panel are LED lamps.

3. The illumination apparatus for LCD/organic displays of claim 2 wherein:
a cover is placed in front of said diffuser panel.

4. The illumination apparatus for LCD/organic displays of claim 2 wherein:
a cover is placed in front of said diffuser panel.

5. The illumination apparatus for LCD/organic displays of claim 2 wherein:
said cover is clear polycarbonate glass.

6. The illumination apparatus for LCD/organic displays of claim 3 wherein:
said cover is clear polycarbonate glass.

7. The illumination apparatus for LCD/organic displays of claim 1 wherein:
said diffuser panel is polycarbonate.

8. The illumination apparatus for LCD/organic displays of claim 2 wherein:
said diffuser panel is polycarbonate.

9. The illumination apparatus for LCD/organic displays of claim 1 wherein:
said diffuser panel is glass.

10. The illumination apparatus for LCD/organic displays of claim 2 wherein:
said diffuser panel is glass.

11. The illumination apparatus for LCD/organic displays of claim 3 wherein:
said diffuser panel is polycarbonate.

12. The illumination apparatus for LCD/organic displays of claim 1 wherein:
said diffuser panel is glass.

13. The illumination apparatus for LCD/organic displays of claim 2 wherein:
said diffuser panel is glass.

14. The illumination apparatus for LCD/organic displays of claim 1 wherein:
said first panel has a white background around the sources of light.

15. The illumination apparatus for LCD/organic displays of claim 2 wherein:
said first panel has a white background around the sources of light.
